(19) United States
(12) Patent Application Publication
(10) Pub. No.: US 2008/0264852 A1
(43) Pub. Date: Oct. 30, 2008

(54) Filtration Cassettes

(75) Inventors: Martin J. Weinstein, South Dartmouth, MA (US); Michelle D. Lyman, Peabody, MA (US)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES CORP., PISCATAWAY, NJ (US)

(21) Appl. No.: 11/572,139

(22) PCT Filed: Jul. 8, 2005
(86) PCT No.: PCT/US05/24268

§ 371 Date: Jul. 17, 2008

Related U.S. Application Data
(60) Provisional application No. 60/588,479, filed on Jul. 16, 2004.

(51) Int. Cl. B01D 63/08; B01D 65/00; B01D 69/06

(52) U.S. Cl. 210/346

(57) ABSTRACT

The present invention relates to filtration cassette, components thereof and methods of making them. A filtration cassette comprises a plurality of subassemblies of which at least one comprises a filter screen encompassed by two filter membranes or one filter membrane and an impermeable film which are joined together around their peripheries.

### FIELD OF THE INVENTION

The present invention pertains to filtration cassettes, components thereof, and methods for manufacturing them.

### PRIOR ART

Cassette filtration devices have become the standard in many high technology filter applications such as in biopharmaceutical processing, virus removal from blood products, as well as water purification. Cassette filters are well known in the art and typically include a number of filter elements selectively bound together with a flowable resin so as to define internal channels for the distribution of feed, filtrate, and retentate streams therethrough. Typically, the channels are either open or polymer based screens or plates with the appropriate openings that serve to space the filter elements from each other. The use of polymer screens in the formation of distribution layers provides a high degree of flow uniformity as well as good control of the shear imparted to the fluids. Examples of prior art filtration cassettes are provided by U.S. Pat. No. 4,715,955 to Friedman and U.S. Pat. No. 5,866,930 to Kopf, International Patent Application number WO2003/088864 to Herczeg, the teachings of which are incorporated by reference herein.

Typical cassette manufacture involves first cutting each of the flow screens and the filtration membranes into identically sized pieces which are in the shape of the cassette. The flow screens are made of one type of material and the filtration membranes are made of different type of material. Filtrate and retentate subassemblies are made in which flow is blocked by drawing a flowable resin about certain holes cut in the elements. Filtrate screen subassemblies include an elongate planar filtrate screen having a similar sized filter membrane positioned over each major surface. Each of these members of the filtrate screen subassemblies defines registered apertures for conducting either feed fluid, filtrate fluid, or retentate fluid through the assembled cassette. In the case of filtrate screen subassemblies, apertures utilized in the distribution of feed and retentate streams are blocked with the resin so as to allow those streams to pass therethrough without access to the filtrate screen. The feed and retentate subassemblies, each composes of only a single feed or retentate screen, include similarly registered apertures for mating with the filtrate subassemblies. In the feed and retentate subassemblies, the holes utilized for the distribution of filtrate streams are parametrically sealed with the flowable resin so as to prevent mixing with the feed/retentate streams. The result of stacking these subassemblies is a filtration cassette having a plurality of holes therethrough for accommodating the separation of the filtrate streams from the feed and retentate streams. The stack of these subassemblies is also parametrically sealed with a flowable resin to provide the mechanical integrity and to completely define all of the flow channels necessary for operation.

The application of the flowable resin in each of these steps is accomplished in three steps. First, a number of feed/retentate screens are stacked in a mold with an impermeable spacer layer placed between each screen. The flowable resin is injected into each elongate cavity formed by the overlying filtrate apertures. The mold is then closed about the stack of screens and a vacuum is applied to the mold cavity so as to draw the resin into the screens sufficiently to form a fluid-tight gasketing seal about those apertures. Second, a number of filtrate subassemblies are stacked in a mold with an impermeable spacer layer placed between adjacent subassemblies. The flowable resin is injected into each elongate cavity formed by the overlying feed and retentate apertures. The mold is closed about the stacked subassemblies and a vacuum is applied to the mold cavity to draw the resin into the screens sufficiently to form a fluid-tight seal about those apertures. Upon the resin hardening, the screen and an overlying and underlying filter membrane are permanently joined about the feed/retentate apertures. Third, the final encapsulation step of the entire cassette requires all of the subassemblies to be appropriately stacked and the resin introduced around the periphery of the assembly. Again, a vacuum is drawn on the interior of the assembly through the all of the apertures and the resin is drawn into the perimeter of the parts, thereby binding the stack permanently.

FIG. 1 depicts the general structure of a prior art filtration cassette 10. Cassette 10 includes a housing 12 surrounding an assembly 14 of a first and second impermeable film 16 and 18, first and second feed/retentate subassemblies 17 and 19, and filtrate subassembly 25. Feed/retentate subassemblies 17 and 19 include an elongate planar porous mesh or screen 20 and 22, respectively, which incorporate gaskets 21 for directing two flow streams therethrough. Feed/retentate screens 20 and 22 define first and second elongate feed/retentate passageways 30 and 32, respectively, as well as feed/retentate ports 36 and 38 and filtrate ports 40 and 42. Each filtrate subassembly 25 includes a first and second filter membrane 24 and 26 partially attached to a similar-shaped filtrate screen 28. Filtrate screen 28 defines an elongate filtrate passageway 34 while filtrate screen 28 and filter membranes 24 and 26 define both first and second feed/retentate ports 36 and 38 and first and second filtrate ports 40 and 42. Subassembly 25 includes gaskets 31 which isolate feed/retentate ports 36 and 38 from filtrate passageway 34. Gaskets 31 further serve to bond filter membranes 24 and 26 to filtrate screen 28.

Subassemblies 17, 19, and 25 thereby define registered apertures comprising first and second feed/retentate ports 36 and 38 extending in fluid communication with feed/retentate passageways 30 and 32 and registered apertures comprising first and 20 second filtrate ports 40 and 42 extending in fluid communication with filtrate passageway 34. Gaskets 21 and 31 serve to isolate the feed/retentate stream from the filtrate steam of cassette 10. Filter membranes 24 and 26 allow the filtrate component of the feed stream to pass from feed/retentate passageways 30 and 32 into filtrate passageway 34. Filter membranes 24 and 26 are desirably selected from the group comprising ultrafiltration flat sheet membranes, microfiltration flat sheet membranes and may optionally be selected to be either asymmetric or symmetric membranes as are known in the art. Impermeable films 16 and 18 are also optionally discarded from cassette 10 if the cassette is to be used in a filtration fixture which has walls which can seal against the top and bottom of the cassette. A sealing resin (not shown) may be provided to parametrically seal the edges of the filtration media and the porous mesh as well as to seal the apertures defined thereby so as to render the feed/retentate passageways in obstructed fluid communication with the filtrate passageways only through the filter media. The sealing resin defines at least an end portion of a fluid channel in each passageway. Optionally a cassette may utilise a plurality of filtrate subassemblies 25 in which case a further filtrate screen 28 is positioned between each such subassembly—as shown in dotted lines in FIG. 1.

### SUMMARY OF THE INVENTION

The present invention relates to improved filter cassettes and improved methods for making such cassettes.

### BRIEF DESCRIPTION OF THE FIGURES

FIG. 1 depicts a partially exploded view of a typical prior art filtration cassette assembly of the prior art.

FIG. 2 is a plan view of one embodiment of a filtrate subassembly according to the present invention.

FIG. 3 is an exploded view of the filtrate assembly of FIG. 2.

FIG. 4 is a partially exploded view of an embodiment of a filtration cassette according to the present invention.

FIG. 5 is a process chart representing a method for making subassemblies and cassette assemblies in accordance with one embodiment of the present invention.

FIG. 6 is a plan view of an intermediate filtrate screen in accordance with one embodiment of the present invention.

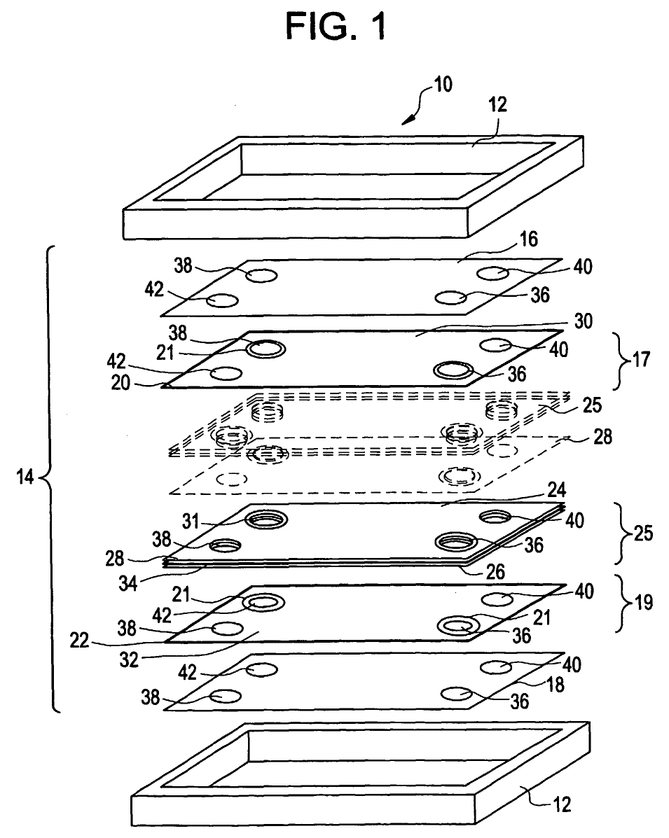

### DETAILED DESCRIPTION OF EMBODIMENTS ILLUSTRATING THE INVENTION

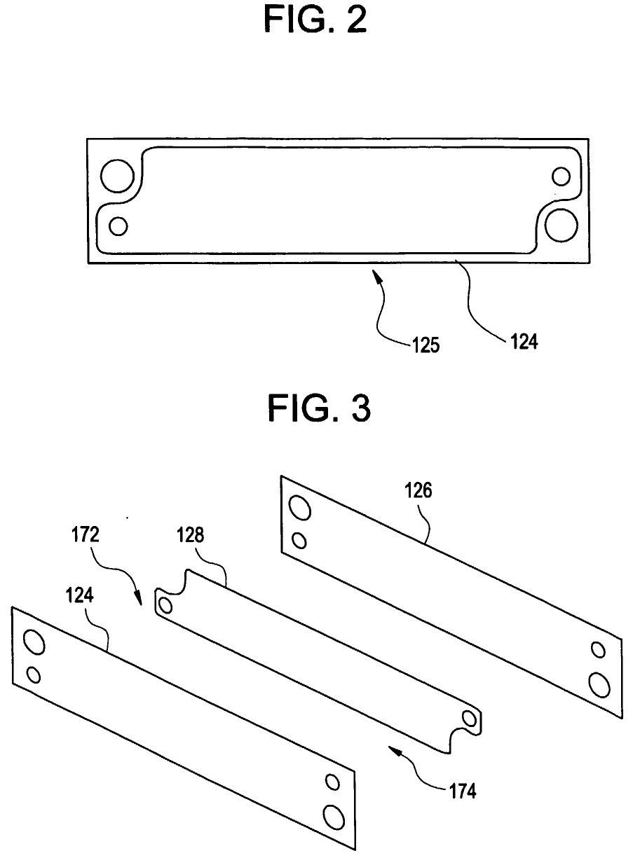

FIG. 2 is a plan view of one embodiment of a filtrate subassembly 125 according to the present invention. The dimensions shown are for illustrative purposes only and are in inches. In this embodiment filtrate subassembly 125 includes a first and second filter membrane 124 and 126 which surround a specially shaped filtrate screen 128. In this embodiment of the present invention first and second filter membranes 124, 126 are identically shaped rectangular pieces of membrane material (for example, polyethersulfone which has a glass transition temperature of 220° C.) in which the first set of diagonally opposite corners are provided with first and second feed/retentate ports 136, 138, and the second set of diagonally opposite corners are provided with first and second filtrate ports 140, 142. Filter screen 128 is made of a piece of screen material (for example, polypropylene such as Propyltex™ from Sefar (catalogue no. 05-420/30) which has a melting point of 165° C.) in the shape of a rectangle with rounded corners, two of which have been removed leaving projecting tabs 172, 174 which leave the filter screen in the form of an elongated Z-shape. The two corners which are removed are diametrically opposed and are the corners which correspond to the corners of the filter membranes 124, 126 which have the first and second feed/retentate ports 136, 138. The two projecting tabs 172, 174 of filter screen 128 are provided with first and second filtrate ports 140, 142 which are positioned so that in use they are aligned with the filtrate ports of filter membranes 124, 126. The amount of material removed from the two corners of filter screen 128 and the size of filter screen 128 are adapted so that when a filter screen is placed on a filter membrane 124, 126 with its filtrate ports 140, 142 aligned with the filtrate ports of the filter membrane, then there is a distance of at least 1 mm, preferably at least 2 mm and most preferably 3 mm from the edges of the filter screen to the nearest feed/retentate port on the filter membrane 124, 126, and at least 1 mm, preferably at least 2 mm and most preferably 3 mm from the edges of the filter screen to the closest edge of the filter membrane. In a preferred method to form a filtrate subassembly 125, a filter screen 128 is placed between a pair of filter membranes 124, 126 with all the filtrate ports 140, 142 aligned with each other. As the membranes 124,126 are bigger than the filter screen 128, the edges of the filter membrane 124 can be brought into contact with the corresponding edges of filter membrane 126 and joined together. This may be achieved by welding or gluing. Preferably, where practical, all of the portions of the filter membranes 124, 126 which are in contact with each other are joined together. By including the regions around the feed/retentate ports 136, 138 in the joining process and ensuring that the joining process closes the pores in the membrane material at the contact surfaces between the two filter membranes a seal can be made around these ports 136, 138 without the use of any gaskets or sealant. In a preferred embodiment of the present invention, the filter screen 128 is not joined to the filter membranes 124, 126 but is left floating between them. This can be achieved by arranging the filter membranes and filter screen in a fixture, heating the mutually contacting surfaces of the filter membranes using an appropriately shaped heated tool for a predetermined length of time until the mutually contacting surfaces of the filter membranes flow together and then cooling the mutually contacting surfaces of the filter membranes so that a heat seal is formed around the filter screen 128 and the ports 136, 138. Owing to the low thermal conductivity of the polyethersulfone used to make the filter membranes 124, 126 it is possible to heat them to their glass transition temperature of 220° C. at a distance of only a few hundredths of a millimeter from the filter screen 128 without melting the filter screen 128 which melts at 165° C.

FIG. 3 is an exploded view of the filtrate assembly 125 of FIG. 2, showing first filter membrane 124, filter screen 128 and second filter membrane 126.

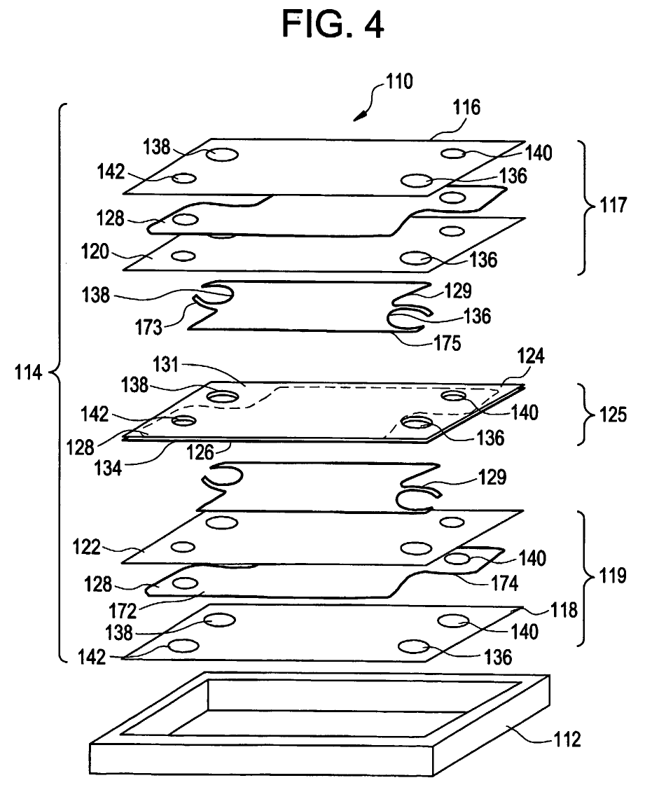

FIG. 4 shows in an exploded view the general structure of an embodiment of a filtration cassette 110 in accordance with the present invention. Cassette 110 includes an edge 112 surrounding a layered filtration cassette assembly 114 comprising a top subassembly 117, a bottom subassembly 119 and at least one filtrate subassembly 125. Each top and bottom subassembly 117, 119 comprises a filter screen 128 enclosed in an envelope comprising a rectangular piece of impermeable film 116, 118 (made, for example from PETG-glycol modified polyethylene terephthalate which has a glass transition temperature of about 175-180° C.), joined to a similar shape and sized piece of filter membrane 120, 122. Preferably the components of the top and bottom subassemblies are heated sealed together in the same way as the components of the subassembly 125. When arranged in a filtration cassette the impermeable sides of the top and bottom subassemblies face outwards.

As described previously, each filtrate subassembly 125 includes a first and second filter membrane 124 and 126 which encloses a smaller-sized filtrate screen 128. Filtrate screen 128 defines an elongate filtrate passageway 134. Filter membranes 124 and 126 define both first and second feed/retentate ports 136 and 138 and first and second filtrate ports 140 and 142, while filter screen 128 only defines first and second filtrate ports 140, 142. Subassembly 125 includes sealed regions 131 which isolate feed/retentate ports 136 and 138 from filtrate passageway 134.

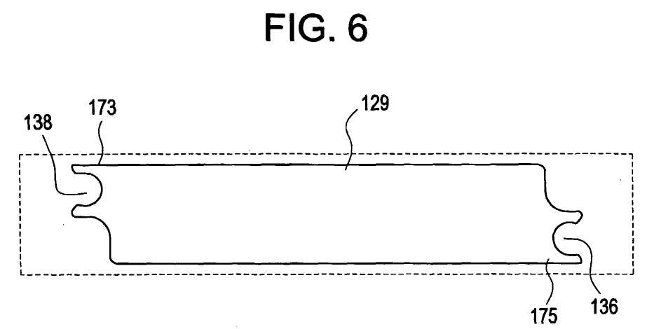

Sealed regions 131 further serve to bond filter membranes 124 and 126 to each other. Subassemblies 117, 119, and 125 thereby define registered apertures comprising first and second feed/retentate ports 136 and 138 extending in fluid communication with feed/retentate passageways 130 and 132 and registered apertures comprising first and second filtrate ports 140 and 142 extending in fluid communication with filtrate passageway 134. Sealed regions 131 serve to isolate the feed/retentate stream from the filtrate steam of cassette 110. Filter membranes 124 and 126 allow the filtrate component of the feed stream to pass from feed/retentate passageways 130 and 132 into filtrate passageway 134. Filter membranes 124 and 126 are desirably selected from the group comprising ultrafiltration flat sheet membranes, microfiltration flat sheet membranes and may optionally be selected to be either asymmetric or symmetric membranes as are known in the art. Optionally a cassette may utilise a plurality of filtrate subassemblies 125 in which case an intermediate filtrate screen 129 is positioned between each such subassembly. Intermediate filter screen 129 is made of a piece of screen material (for example, polypropylene such as Propyltex™ from Sefar (catalogue no. 05-420/30) which has a melting point of 165° C.) in the shape of a rectangle with rounded corners, two of which have been removed leaving projecting tabs 173, 175 which leave the filter screen in the form of an elongated Z-shape. The two corners which are removed are diametrically opposed and are the corners which correspond to the corners of the filter membranes 124, 126 which have the filtrate ports of filter membranes 124, 126. The two projecting tabs 173, 175 of intermediate filter screen 129 are provided with first and second feed/retentate ports 136, 138 which are positioned so that in use they are aligned with the first and second feed/retentate ports 136, 138 of filter membranes 124, 126. The amount of material removed from the two corners of intermediate filter screen 129 and the size of intermediate filter screen 129 are adapted so that when a filter screen is placed on a filter membrane 124, 126 with its first and second feed/retentate ports aligned with the first and second feed/retentate ports of the filter membrane, then there is a distance of at least 1 mm, preferably at least 2 mm and most preferably 3 mm from the edge of each of tabs to the nearest filtrate port on the filter membrane 124, 126, and at least 1 mm, preferably at least 2 mm and most preferably 3 mm from the edges of the filter screen to the closest edge of the filter membrane. Preferably the projecting tabs 173, 175 of intermediate filter screen 129 are shortened so that the first and second feed/retentate ports 136, 138 are open towards the short sides of the intermediate filter screen 129 as shown in FIG. 6.

A layered filtration cassette assembly 114 can be made by stacking a top subassembly 117 and one or more filtrate subassemblies 125 onto a bottom assembly 119. This can be achieved by placing a bottom assembly with the impermeable file side facing downwards into a fixture, applying a pattern of melted resin such as Eastman Provista 21019BG (available from Eastman Chemical Company, Kinsport Tenn. 37662-5280 USA) around the filtrate ports and the perimeter of the upward facing filter membrane of the bottom subassembly, aligning the ports in a intermediate filter screen with the ports in the bottom subassembly and placing it on bottom assembly, aligning the ports in a filtrate subassembly with the ports in the bottom assembly and placing it onto the melted resin, and pressing the filtrate subassembly towards the bottom subassembly while allowing the resin to solidify. This process is repeated until the rest of the filtrate subassemblies and the top subassembly is stacked with the impermeable film facing upward. The resin fulfils two functions, namely to hold the layers of the layered filtration cassette assembly to each other while the filtration cassette is being manufactures and to provide a temporary seal between the outside of the cassette and the filtrate/feed/retentate passageway before the edging is applied to the layered filtration cassette assembly.

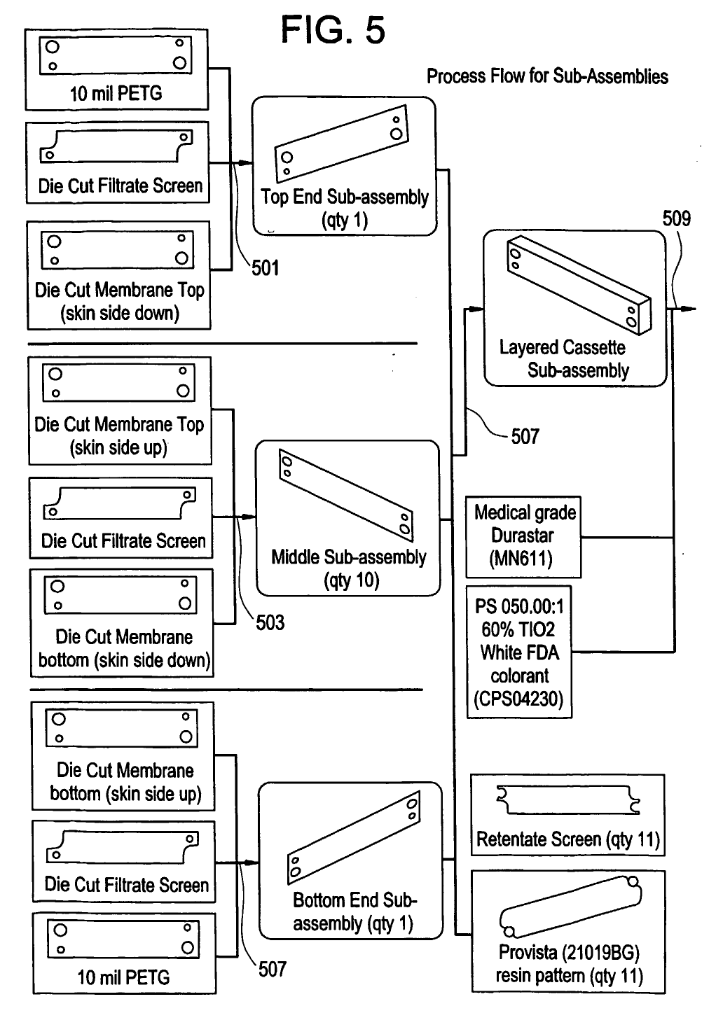

As shown in FIG. 5, a filtration cassette can be made by placing a layered filtration cassette assembly 114 into a fixture and molding an encapsulating edging 112 around the layered filtration cassette assembly. The edging can be applied by insert molding, injection molding, vacuum molding, extrusion or the like and is preferably impermeable.

FIG. 5 illustrates the process flow for making the above-mentioned subassemblies and assembling them to form a 12-layer filtration cassette comprising one top subassembly, one bottom subassembly and 10 filtrate subassemblies. At 501 a top subassembly 117 is formed from a shaped piece of PETG 116, a die cut filtrate screen 128 and a die cut membrane sheet 120, the PETG and membrane sheet being heat sealed together. At 503 a filtrate subassembly is formed from a die cut filtrate screen 128 enclosed in two filter membranes 124, 126, the two membrane sheets being heat sealed together. At 505 a bottom subassembly 119 is formed from a shaped piece of PETG 118, a die cut filtrate screen 128 and a die cut membrane sheet 122, the PETG and membrane sheet being heat sealed together. At 507 a layered subassembly is formed by placing a bottom subassembly in a fixture aligning a filtrate screen on it, applying Provista (21019BG) resin in the appropriate pattern, pressing the subassemblies together, adding 10 filtrate subassemblies—each separated by an intermediate filtrate screen 129 and an extruded pattern of resin and each additional subassembly being pressed together with the already present subassemblies before a further subassembly is added, adding a further intermediate filtrate screen 129 and an extruded pattern of resin and then applying the top subassembly to the top of the stack of subassemblies. The stack of subassemblies is allowed to cool sufficiently to allow the resin to harden. At 509 the encapsulating edging of impermeable material, for example, medical grade Durastar (MN611) and pigment PS 050.00:1 60% TiO₂ White FDA colorant (CPS04230) is insert molded onto the stack.

In a further embodiment of the present invention, instead of the encapsulating material being insert molded onto the stack, a pre-shaped pattern of encapsulating material is cut out of a sheet of impermeable material and positioned between each pair of subassemblies as the stack of subassemblies is being built. The cassette is then compressed under a temperature above the melt point of the thermoplastic, preferably in a fixture to ensure proper cassette geometry.

In a further embodiment of the present invention, a large cassette is formed by combining a plurality of cassettes together. This can be achieved by stacking one cassette on top of at least one other cassette with their ports aligned and then joining the adjacent surfaces of the cassettes together, for example by heating or the use of an adhesive. Alternatively, or additionally, the cassettes may be taped together using an adhesive tape which overlaps the join between the cassettes.

While the preferred embodiment of the present invention has been shown and described, it will be obvious in the art that changes and modifications may be made without departing from the teachings of the invention. The matter set forth in the foregoing description and accompanying drawings is offered by way of illustration only and not as a limitation. For example, the present invention is not intended to be limited to the specific shapes of the subassemblies, components, apertures and notches disclosed herein. The actual scope of the invention is intended to be defined in the following claims when viewed in their proper perspective based on the prior art.

1: An assembly for a filtration cassette comprising: a first layer, a second layer, and a third layer; wherein the first and third layers have peripheries, wherein the first and third layers have substantially the same shape and size as each other and are sealed to each other around their peripheries; and said second layer is arranged between said first and third layers.

2: The assembly of claim 1, wherein said second layer has a smaller size than said first and third layers.

3: The assembly of claim 1, wherein said second layer is of a smaller size than said first and third layers and is floating between said first and third layers.

4: The assembly of claim 1, wherein said first layer is made from an impermeable material, said second layer is made from a filter screen material and said third layer is made from a filter membrane material.

5: The assembly of claim 2, wherein said first layer is made from an impermeable material, said second layer is made from a filter screen material and said third layer is made from a filter membrane material.

6: The assembly of claim 3, wherein said first layer is made from an impermeable material, said second layer is made from a filter screen material and said third layer is made from a filter membrane material.

7: The assembly of claim 1, wherein said first layer and third layer are made from a filter membrane material and said second layer is made from a filter screen material.

8: The assembly of claim 2, wherein said first layer and third layer are made from a filter membrane material and said second layer is made from a filter screen material.

9: The assembly of claim 3, wherein said first layer and third layer are made from a filter membrane material and said second layer is made from a filter screen material.

10. (canceled)

11: A method of forming an assembly comprising: providing a first layer, a second layer and a third layer wherein the first and third layers have substantially the same shape and size as each other; arranging said second layer between said first and third layers; and sealing peripheries of said first and third layers to each other.

12: The method of claim 11, wherein said sealing is performed by heat sealing.

13: A method for forming a filtration cassette comprising: providing a stack of assemblies wherein each assembly is separated from its neighbouring assembly or assemblies by a filter screen; joining each assembly to its neighbouring assembly or assemblies; and encapsulating the stack around its edges with an impermeable material.

14: The method of claim 13, wherein the impermeable material around the edges is an extruded thermoplastic.

15: The method of claim 13, wherein the impermeable material around the edge is fabricated from sheet thermoplastic and melted or bonded between the filter screen assemblies.

16. (canceled)
